(19) United States
(12) Patent Application Publication
(10) Pub. No.: US 2016/0331627 A1
(43) Pub. Date: Nov. 17, 2016

(54) A BREAST MASSAGER

(71) Applicant: KONIKLIJKE PHILIPS N.V., Eindhoven (NL)

(72) Inventors: KLAAS KOOIJKER, EINDHOVEN (NL); GERTRUDE RIËTTE VAN DER KAMP, EINDHOVEN (NL); XIN CHEN, EINDHOVEN (NL)

(21) Appl. No.: 15/111,045

(22) PCT Filed: Jan. 23, 2015
(86) PCT No.: PCT/IB2015/050519

§ 371 Date: Jul. 12, 2016

(30) Foreign Application Priority Data
Jan. 23, 2014 (CN) PCT/CN2014/071227

(51) Int. Cl. A61H 7/00; A61H 15/00; A61H 1/00

(52) U.S. Cl. CPC A61H 7/007; A61H 1/008; A61H 15/0085; A61H 2201/1436; A61H 2201/1671; A61H 2201/1695; A61H 2205/082; A61H 2015/0042

(57) ABSTRACT

A breast massager (not shown) arranged to provide a combing motion is provided. The breast massager comprises a number of linearly arranged massaging protrusions (2) which perform a circular or elliptical motion in a plane coinciding with the linear arrangement of the massaging protrusions (2) and perpendicular to a skin of a woman's breast (1). The massaging protrusions (2) are arranged to invoke a linear arrangement of local areas of increased pressure on the skin varying in position and pressure during the circular or elliptical motion.

### FIELD OF THE INVENTION

The invention relates to a breast massager comprising a support surface in a support plane arranged to extend substantially parallel to a skin of a user's breast, an actuator and at least two massaging protrusions coupled to each other.

### BACKGROUND OF THE INVENTION

The benefits of breastfeeding have been demonstrated by a large body of research. Exclusive breastfeeding for the first six months and continued breastfeeding up to two years of age or beyond are recommended by WHO (World Health Organization). However, in some countries the breastfeeding ratio is rather low.

One of the most common reasons why a mother stops breastfeeding her baby is that she suffers from breast inflammation. This is highly unwanted, because breastfeeding reduces the risk of many illnesses and conditions, such as infections and obesity for the baby and reduces the development of breast cancer for the mother. Breast inflammation occurs when a milk duct is not draining well and gets plugged or clogged and inflammation builds up. If the plugged area is not drained, pressure can build up behind it and cause the surrounding tissue to become inflamed. The area around the plugged or clogged duct may be warm and red, and, if it is located in a duct close to the surface of the skin, one may be able to feel the area. Preventing breast inflammation is very important because the inflammation will eventually cause fever and often needs to be treated by antibiotics. Antibiotics will diffuse into the breast milk and will be transferred to the baby, which is highly unwanted.

To prevent breast inflammation the best way is to massage the problematic duct while breastfeeding. However, holding the baby with one hand, while performing a correct massaging motion on the breast with the other hand is very complex and difficult to perform. For many mothers breast inflammation is the reason to stop breastfeeding their babies, despite the positive effects for the mother and her baby.

U.S. Pat. No. 4,633,858 discloses a massaging device utilizing crankshafts housed in a casing. Connecting rods are mounted to the crankpins of the crankshafts and extend through elliptical guide holes formed in the upper surface of the casing. These guide holes are disposed in a staggered relationship. The crankshafts are driven at one end and the movement of the connecting rods corresponds to a kneading motion. The massage device is intended for massaging muscles. The massage device is not suitable for breastfeeding.

### SUMMARY OF THE INVENTION

It is an object of the invention to provide a massager suitable for draining milk from the milk ducts in the mother's breast.

According to the invention this object is realized in that the breast massager comprises a support surface in a support plane arranged to extend substantially parallel to a skin of a user's breast, an actuator and at least two massaging protrusions coupled to each other, the massaging protrusions being linearly arranged parallel to the support plane and the actuator being arranged to drive the massaging protrusions in a circular or elliptical motion in a plane coinciding with the linear arrangement of the massaging protrusions and perpendicular to the support plane, and the massaging protrusions being arranged to extend through the support plane, the extension varying during the circular or elliptical motion.

The massaging protrusions are linearly arranged with respect to each other and parallel to the support plane. The massaging protrusions are driven by the actuator and perform a circular or elliptical motion in a plane perpendicular to the support plane and in the direction of the linear arrangement of the massaging protrusions. The massaging protrusions are arranged to pass through the support plane during the circular or elliptical motion. During the circular or elliptical motion the pressure of the protrusions onto the breast changes from a minimum when the massaging protrusions are in their retracted position to a maximum when the protrusions are in their extended position. The pressure executed by the massaging protrusions onto the user's breast increases when the massaging protrusions pass through the support plane and decreases when the protrusions withdraw from their extended position through the support plane. When a number of linearly arranged massaging protrusions each execute a circular or elliptical motion through the support plane, the number of protrusions performs a movement mimicking a combing, or peristaltic motion, which is helpful in preventing milk ducts from getting clogged or plugged.

The massaging protrusions are arranged to invoke a linear arrangement of local areas of increased pressure on the skin varying in position and pressure during the circular or elliptical motion. To prevent breast inflammation the best way is to massage the problematic duct while breastfeeding. The breast massager is held in one hand, while the other hand of the mother is holding the baby. The breast massager thus enables to massage the breast in the right way to drain milk from the milk ducts, while breastfeeding the child.

Advantageously, the amount of extension of the protrusions through the support plane is zero during a part of the circular or elliptical motion. At this part of the circular or elliptical motion no pressure is executed onto the breast. From this part the combing cycle can start again. The amount of pressure perpendicular to the user's breast periodically varies from zero to a maximum and therefore helps the milk in the milk ducts to flow towards the nipple and drain the milk ducts and decreases the possibility of inflammation.

Advantageously each massaging protrusion is arranged to start extending through the support phase at a different phase angle of the circular or elliptical motion. Each massaging protrusion is positioned at a different angle with respect to the axis or rotation of the massaging protrusion. In this way a local area of increased pressure is created by the movement of a massaging protrusion perpendicular to the plane, arising after a neighbouring local area of increased pressure is created by a neighbouring massaging protrusion. Thus a frequency shift is created. The local areas of increased pressure thereby create a sequence or wave of increased pressure that passes along the plane, such that a massage motion is achieved which stimulates the milk to flow into the direction of the nipple more smoothly. This is beneficial for removing plugs inside the milk ducts.

In a preferred embodiment the massaging protrusions are coupled by a stiff beam. The result of this construction is that the massaging protrusions all perform the same movement, when applied to the breast. Also the breast massager can be manufactured more easily this way. When all massaging protrusions perform the same motion, the massaging protrusions stimulate the milk to flow towards the nipple and to drain the milk duct.

Preferably the massaging protrusions and the stiff beam are integrally formed. The stiff beam and the massaging protrusions are made of one piece which enables easy manufacturability and minimize the tolerance between the different massaging protrusions. The massaging protrusions then perform the same motion and therefore help to flow the milk towards the outlet of the milk duct, the nipple, and to drain the milk duct in the breast.

Advantageously the stiff beam is driven by a crankshaft and the crankshaft is driven by the actuator. A crankshaft mechanism is used to convert a rotation of the actuator into a circular/elliptical motion of the massaging protrusions for the massaging motion. The crankshaft is driven by the actuator to make the massaging motion. A second crankshaft is connected to the stiff beam and follows the motion of the driven crankshaft. The second crankshaft helps to perform a stable motion of the massaging protrusions. When the crankshaft rotates, the massaging protrusions each perform a circular or elliptical motion in the direction perpendicular to the support plane and in the direction of the linear arrangement of the massaging protrusions. The actuator thus indirectly drives the protrusions to perform a comb-like motion. This helps in preventing clogged or plugged ducts.

The crankshaft is arranged to execute a circular motion. A circular motion of the crankshaft is directly transmitted to a circular motion of the massaging protrusions. The massaging protrusions each perform a circular motion. The protrusions perform in this way synchronous circular motions. The synchronous circular motions help to flow the milk towards the outlet of the milk duct at the nipple. This is beneficial for preventing clogged milk ducts.

In a preferred embodiment the first protrusion is coupled to a first gear wheel, a second protrusion is coupled to a second gear wheel and an intermediate gear wheel is coupled to the first gear wheel and the second gear wheel, while the first gear wheel is arranged to be driven by the actuator. The actuator is arranged to drive the first gear wheel, the first gear wheel transmits the rotational motion to the intermediate gear wheel. The intermediate gear wheel consequently drives the second gear wheel. The first massaging protrusion is coupled to the first gear wheel and the second massaging protrusion is coupled to the second protrusion. The first gear wheel drives the circular or elliptical motion of the first protrusion, while the second gear wheel drives the circular or elliptical motion of the second protrusion. Because the first and the second gear wheel are coupled via the intermediate gear wheel and the actuator is arranged to drive the first gear wheel, the second gear wheel is driven via a transmission of circular motions of the first gear wheel and the intermediate gear wheel. In this way the actuator thus drives all gear wheels and thus all massaging protrusions of the breast massager, enabling a combing massaging motion.

In another preferred embodiment the first protrusion is coupled to a first gear wheel, a second protrusion is coupled to a second gear wheel, a gear belt is coupled to the first gear wheel and the second gear wheel and the gear belt is arranged to be driven by the actuator. The first and the second gear wheel are coupled to the gear belt. The actuator is arranged to drive the gear belt. The gear belt is coupled to the first gear wheel and to the second gear wheel and drives the first and the second gear wheels. The first gear wheel is coupled to the first protrusion and the second gear wheel is coupled to the second protrusion and by driving the gear wheels, the actuator drives the massaging protrusions. Thus the protrusions perform a comb-like motion. Applying a gear belt reduces the number of parts of the breast massager and reduces the complexity of manufacturing assembly.

Advantageously the motions differ in amplitude. This allows a woman to adjust the increased pressure at a specific position on the breast which is comfortable to her. Advantageously the massaging protrusions are covered by a plastic sleeve.

The massaging protrusions are covered individually or can alternatively be covered in one single sleeve. The plastic sleeve enables easy cleanability of the breast massager and the massaging protrusions in particular. Easy cleanability is beneficial for hygienic use of the breast massager.

Preferably the massaging protrusions are covered by a rubber or silicone sleeve. The silicone or rubber sleeve enables easy cleanability of the breast massager and the massaging protrusions in particular. Furthermore, silicone and rubber are materials that adopt the temperature of the environment, in this particular situation the skin temperature, and have a skin-like texture, thus enabling the mother with a comfortable breast massaging experience.

In general the embodiments of the invention create local areas of increased pressure on the breast of a user and consequently a sequence or wave of increased pressure that passes along a line in the plane such that the massaging protrusions perform a peristaltic movement.

The breast massager according to the invention can also be used to relieve pain in the breast, not caused by plugged milk ducts, and to promote milk production.

### BRIEF DESCRIPTION OF THE DRAWINGS

These and other aspects of the pacifier of the invention will be further elucidated and described with reference to the drawings in which

FIGS. 1a to 1c disclose a two-dimensional schematic representation of a woman's breast with an applied massaging motion,

FIGS. 2a to 2c show a crosssectional view of a breast massager according to a first embodiment of the present invention,

FIG. 3 shows a sectional view of a breast massager according to a second embodiment of the present invention,

FIG. 4 shows a sectional view of a breast massager according to a third embodiment of the present invention and

FIG. 5 discloses a bottom view of the surface plane during the circular or elliptical motion of the massaging protrusions.

### DETAILED DESCRIPTION OF THE EMBODIMENTS

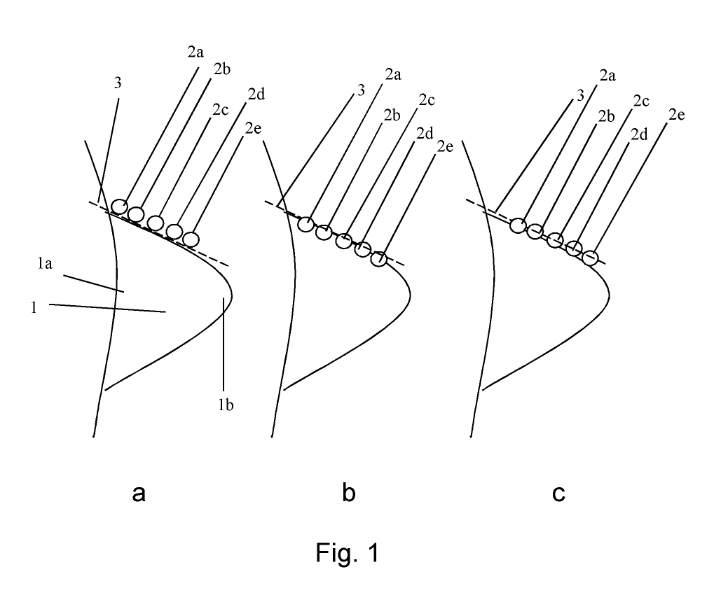

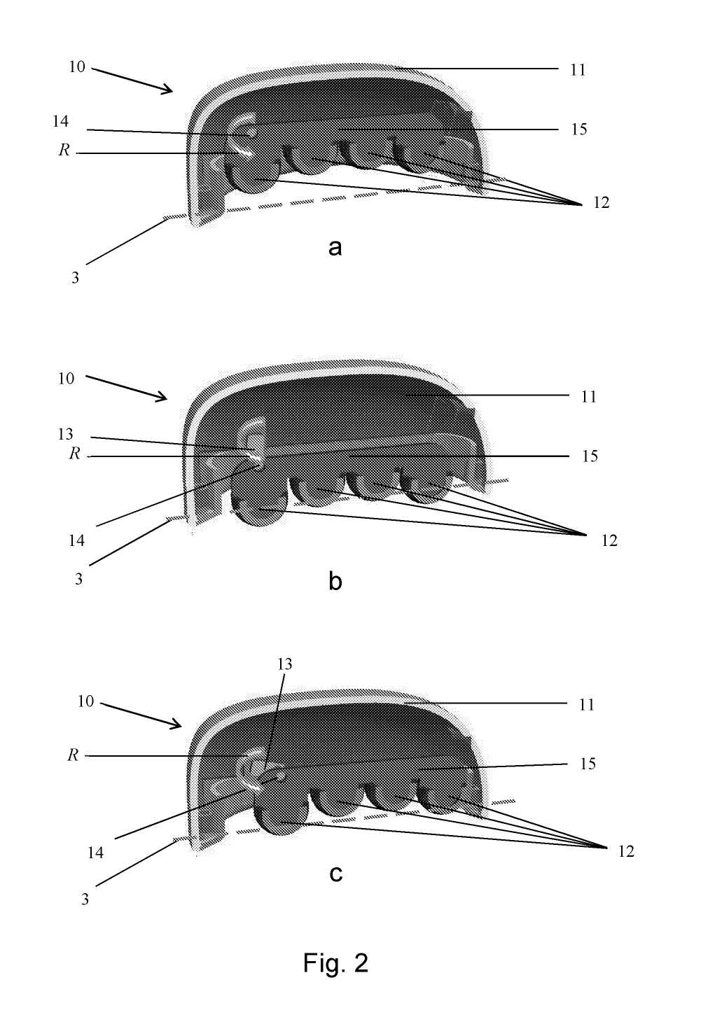

FIG. 1a to 1c show a schematic representation of a woman's breast 1 with four massaging protrusions 2a,2b,2c,2d performing three subsequent steps of a combing motion. An actuator (not shown) drives the four massaging protrusions 2a,2b,2c,2d. The massaging protrusions 2a,2b,2c,2d perform an effectively linear movement onto the skin of the woman's breast 1. A support plane 3 extends substantially parallel to the skin of the user's breast 1 . A support surface (not shown) is part of the breast massager (10,20,30; shown in FIGS. 2 to 4) and lies in the support plain 3 and contacts the skin of the breast 1 beneath the breast massager (10,20,30; shown in FIGS. 2 to 4). The massaging protrusions 2a,2b,2c,2d are linearly arranged parallel to the support plane 3 and the actuator (not shown) is arranged to drive the massaging protrusions 2a,2b,2c,2d in a circular or elliptical motion in a plane coinciding with the linear arrangement of the massaging protrusions 2a,2b,2c,2d and perpendicular to support surface (not shown) of the support plane 3. The massaging protrusions 2a,2b,2c,2d are arranged to extend through the support surface (not shown) of the support plane 3 by a varying amount during the circular or elliptical motion. In FIG. 1a the massaging protrusions 2a,2b,2c,2d touch onto the skin of the breast 1, but do not execute a pressure onto the breast 1. The actuator (not shown) will carry through the circular motion and force the protrusions 12 to pass through the support plane 3 and push the massaging protrusions 2a,2b,2c,2d onto the breast 1, as shown in FIG. 1b, thereby creating local areas of increased pressure. Next, the massaging protrusions will continue the circular or elliptical motion, as shown in FIG. 1c, and relieve the pressure onto the breast 1. At the end of the stroke the massaging protrusions 2a,2b,2c,2d will complete the circular or elliptical movement and will return to the start position shown in FIG. 1a. In the circular motion as shown in FIGS. 1a to 1c the direction of the massaging motion is in the direction from the base 1a of the breast 1 towards the nipple 1b: the circular motion executed by the protrusions moves the protrusions in this direction, while they extend through the support plane 3 and apply pressure to the breast 1. All embodiments of the invention perform a massaging motion to properly drain milk from the milk ducts.

FIGS. 2a to 2c show a first embodiment of a breast massager 10 according to the invention. This embodiment will further be referred to as the first breast massager 10. The first breast massager 10 comprises a housing 11. The housing 11 is for holding the breast massager in the hand. The housing 11 may be designed for a comfortable user experience, for example by means of shape, material use and texture. The housing comprises a crankshaft 13, which is rotatably fixed at one end to the housing 11. The crankshaft 13 is coupled to a stiff beam 15 at the drive end of the crankshaft 13. The drive end of the crankshaft 13 comprises a pin 14 which is arranged to connect to the stiff beam 15. The stiff beam is connected to a number of massaging protrusions 12. In the first breast massager 10 four massaging protrusions 12 are present. The massaging protrusions 12 may vary among others in size and in arrangement with respect to the support surface (not shown) of the support plane 3. The stiff beam 15 and the massaging protrusions 12 may be integrally formed, but may also be connected to each other directly or indirectly, e.g. by a male-female connector. The housing comprises an actuator (not shown) for rotating the crankshaft 13. A second crankshaft (not shown) is connected to the stiff beam 15 at another position to perform a stable motion of the massaging protrusions 12. The second crankshaft (not shown) may be also be driven by the actuator (not shown) or may follow the motion of the crankshaft 13, effectively ensuring that the stiff beam performs a uniform circular motion in a plane perpendicular to the support plane 3.

FIG. 2a shows a starting position of the combing cycle. The stiff beam 15 and the massaging protrusions 12 are in a position in which the massaging protrusions are at the farthest distance from the breast 1, i.e. retracted away from the breast 1. In this position the protrusions 12 do not extend through the support plane 3. The actuator (not shown) drives the crankshaft 13 to perform a circular motion in the direction of arrow R. During the circular motion the massaging protrusions 12 pass through the support surface (not shown) of the support plane 3. FIG. 2b shows the crankshaft 13 is in the opposite tangential position of the position of FIG. 2a and, consequently, the stiff beam 15 and the massaging protrusions 12 in the extended position now touching the breast. In this position the protrusions 12 are at their extended position through the support plane 3. In this position the massaging protrusions exert the highest pressure at local areas of the breast 1. Subsequently the crankshaft continues to rotate further in the direction R, as shown in FIG. 2c, and the massaging protrusions 12 retract away from the breast 1, thus reducing the increased pressure at the local areas of the breast 1. Then the massaging protrusions 12 move further from the breast 1 and further into the housing and in the direction of the first position as shown in FIG. 2a. The circular motion of the crankshaft 15 is thus transferred into a circular motion of the massaging protrusions 12 in a plane perpendicular to the support plane 3. The massaging protrusions 12 slide over the skin of the breast 1. In this way a user can execute a combing motion on a woman's breast 1.

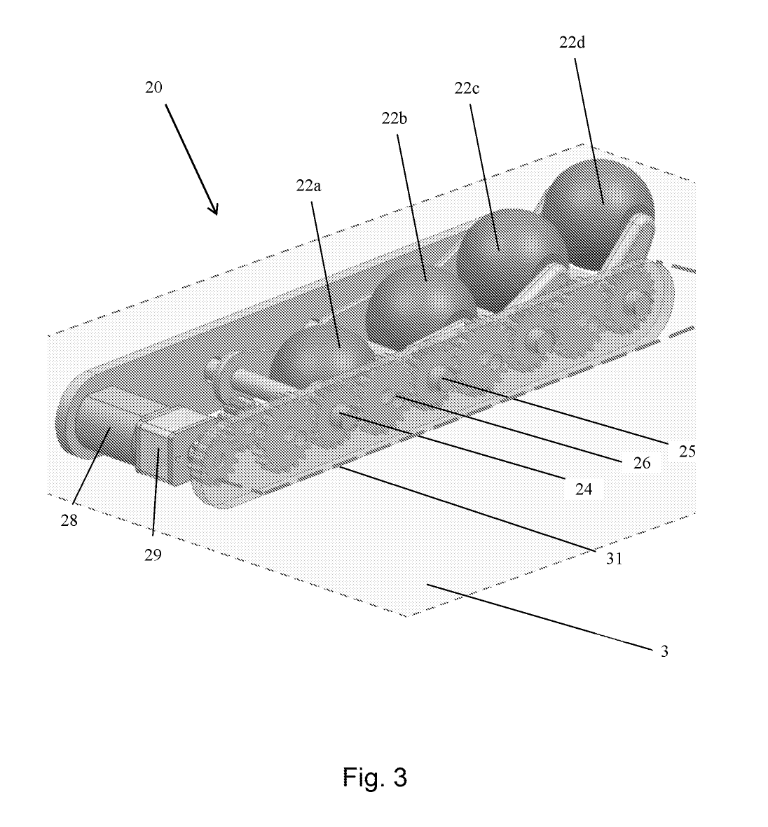

FIG. 3 shows a second embodiment of a breast massager 20 according to the invention. This embodiment will further be referred to as the second breast massager 20. The second breast massager 20 comprises a housing (not shown). The housing (not shown) is for holding the breast massager 20 in the hand. The housing (not shown) may be designed for a comfortable user experience, for example by means of shape, material use and texture. The breast massager 20 further comprises a number of massaging protrusions 22,23 which are each arranged to rotate around a pin (not shown) by means of a number of gear wheels 24,25,26, an actuator 28 and a transmission 29. The actuator 28 is arranged to drive the first gear wheel 24, the first gear wheel 24 transmits the rotational motion to the intermediate gear wheel 26. The intermediate gear wheel 26 is not coupled to a massaging protrusion 22,23.

The intermediate gear wheel 26 consequently drives the second gear wheel 25. A first massaging protrusion 22 is coupled to the first gear wheel 24 and a second massaging protrusion 23 is coupled to the second protrusion 23. Rotation of the first gear wheel 24 causes the first protrusion 22 to perform a circular or elliptical motion in a plane perpendicular to the support plane 3 and coinciding with the linear arrangement of the massaging protrusions 22,23, while the second gear wheel 25 causes the second protrusion 23 to perform a circular or elliptical motion in the same plane as the first protrusion 22. Because the first and the second gear wheel 24,25 are coupled via the intermediate gear wheel 26 and the actuator 28 is arranged to drive the first gear wheel 24, the second gear wheel 25 is driven via a transmission of circular motions of the first gear wheel 24 and the intermediate gear wheel 26. In this way the actuator 28 thus drives all gear wheels 24,25,26 and thus all massaging protrusions 22,23 of the breast massager 20. The massaging protrusions 22,23 perform a circular or elliptical motion in a plane coinciding with the linear arrangement of the massaging protrusions 22,23 and perpendicular to a support surface 31 of the support plane 3. The massaging protrusions 22,23 are arranged to extend through a support surface 31 of the support plane 3 by an amount varying during the circular or elliptical motion. The protrusions 22,23 may start to extend through a support surface 31 of the support plane 3 at a different phase angle. The massaging protrusions 22,23 are thus oriented such that a local area of increased pressure, created by the movement of a massaging protrusion 22,23 perpendicular to a support surface 31 of the support plane 3, arises after a neighbouring local area of increased pressure. The massaging protrusions 22,23 are thus phase shiftedly arranged. In this way the local areas of increased pressure create a sequence or wave of increased pressure that passes along the plane such that the massaging protrusions perform a special version of a combing motion: a peristaltic motion. When the protrusions 22,23 extend at the same time, i.e. no phase differences between the protrusions, a regular combing motion is obtained.

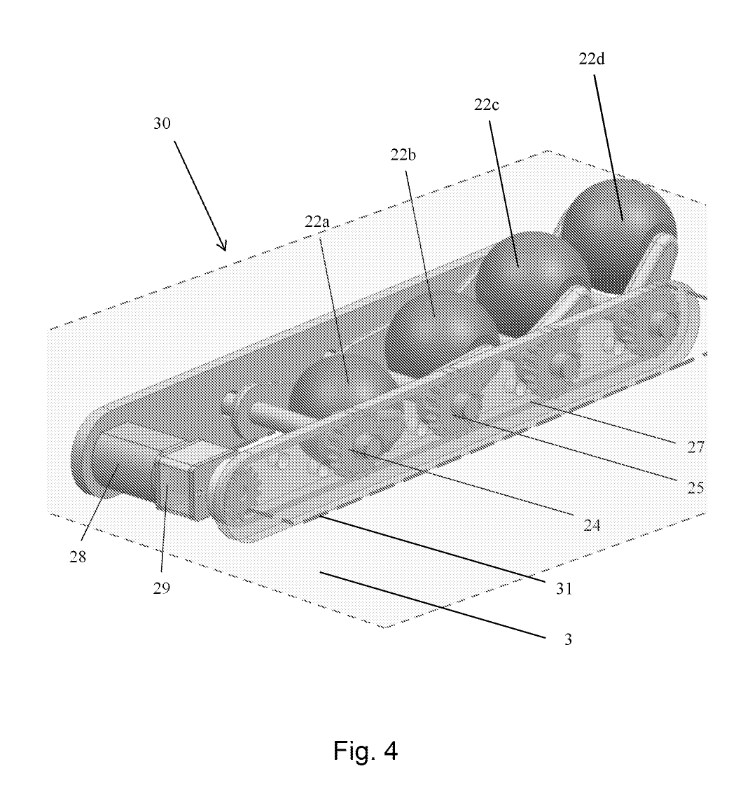

FIG. 4 shows a third embodiment of a breast massager 30 according to the invention. This embodiment will further be referred to as the third breast massager 30. The third breast massager 30 comprises a housing (not shown). The housing (not shown) is for holding the breast massager 30 in the hand. The housing (not shown) may be designed for a comfortable user experience, for example by means of shape, material use and texture. The breast massager 30 further comprises a number of massaging protrusions 22,23 which are each arranged to rotate around a pin (not shown) by means of a gear belt 27, a number of gear wheels 24,25,26, an actuator 28 and a transmission 29. The actuator 28 is arranged to drive the gear belt 27. The first gear wheel 24 is coupled to the gear belt 27. The first gear wheel 24 is driven by the gear belt 27. The gear belt 27 is coupled to the second gear wheel 25 as well and drives the second gear wheel 25. A first massaging protrusion 22 is coupled to the first gear wheel 24 and a second massaging protrusion 23 is coupled to the second gear wheel 25. The first gear wheel 24 drives the circular or elliptical motion of the first protrusion 22, while the second gear wheel 25 drives the circular or elliptical motion of the second protrusion 23. Because the first gear wheel 24 is coupled to the first protrusion 22, the second gear wheel 25 is coupled to the second protrusion 23 and the actuator 28 is arranged to drive the gear belt 27 and the gear belt 27 drives the first and gear wheels 24,25, the massaging protrusions 22,23 are driven by the actuator 28. In this way the massaging protrusions 22,23 perform a circular or elliptical motion in a plane coinciding with the linear arrangement of the massaging protrusions 22,23 and perpendicular to a support surface 31 of the support plane 3. The massaging protrusions 22,23 can be arranged to extend through the support plane 3 by an amount varying during the circular or elliptical motion. The protrusions 22,23 may start to extend through a support surface 31b of the support plane 3 at a different phase angle. The massaging protrusions 22,23 are thus oriented such that a local area of increased pressure, created by the movement of one of the second massaging protrusion 23 perpendicular to the a support surface 31 of support plane 3, arises after a neighbouring local area of increased pressure caused by the first protrusion 22. The massaging protrusions 22,23 are thus phase shiftedly arranged. In this way the local areas of increased pressure create a sequence or wave of increased pressure that passes along the plane such that the massaging protrusions perform a special version of a combing motion: a peristaltic movement.

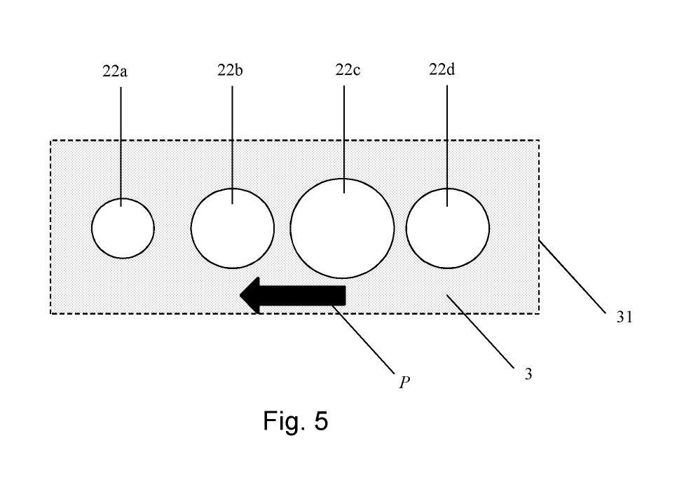

FIG. 5 shows a bottom view of the support plane 3 where the massaging protrusions 22,23 extend through the support surface 31 of the support plane 3 during their circular or elliptical motion. The massaging protrusions 22,23 are coupled to the first and the second gear wheel (not shown) each at a different phase angle. In this way the extension of each massaging protrusion 22,23 through the support plane 3 is different. The larger the view of massaging protrusion 22,23, the further the extension through the support plane 3. By arranging the massaging protrusions 22,23 at a different angle a peristaltic motion is performed, which, when applied in the right direction, stimulates the milk in the milk duct to flow towards the outlet of the milk duct at the nipple and properly drain the milk duct. The arrow P shows the direction of the peristaltic motion.

By rotating the massaging protrusions 22,23 around a pin (not shown) and thus rolling the massaging protrusions 22,23 over the breast 1 as applied in the second and third breast massager 20,30 the contact friction between the massaging protrusions 22,23 and the skin of the breast 1 will be significantly reduced compared to the sliding massaging protrusions 12 of the first breast massager 10. This allows the application of a smaller and weaker actuator 28 to drive all massaging protrusions 22,23.

In all embodiments, the massaging protrusions 12,22,23 can be covered with a sleeve (not shown) made of plastic, rubber, silicone or the like. The massaging protrusions 12,22,23 can be covered individually or all together in one single sleeve (not shown). The sleeve (not shown) enables easy cleanability of the breast massager 10,20,30 and the massaging protrusions 12,22,23 in particular. Easy cleanability is beneficial for hygienic use of the breast massager 10,20,30. Furthermore, silicone and rubber are materials that adopt the temperature of the environment, in this particular situation the skin temperature, and have a skin-like texture, thus enabling the mother with a comfortable breast massaging experience.

When the breast massager 10,20,30 is oriented such that the local areas of increased pressure move in the direction from the base 1a of the breast 1 towards the nipple 1b the milk in the milk ducts is stimulated towards the nipple 1b and the milk ducts will drain properly.

Although for ease of explanation the invention has been described using four or five massaging protrusions 12,22a, 22b, 22c, 22d a breast massager 10,20,30 according to the invention may also comprise a different number of protrusions 12,22a, 22b, 22c, 22d such as 2, 3, 6, 7, 8.

1. A breast massager comprising
a support surface in a support plane arranged to extend substantially parallel to a skin of a user's breast,
an actuator,
at least two massaging protrusions coupled to each other, the massaging protrusions being linearly arranged parallel to the support plane and the actuator being arranged to drive the massaging protrusions in a circular or elliptical motion in a plane coinciding with the linear arrangement of the massaging protrusions and perpendicular to the support plane, thus performing a movement mimicking a combing or peristaltic motion, and the massaging protrusions being arranged to extend through the support plane, the extension varying during the circular or elliptical motion.

2. A breast massager according to claim 1, wherein the amount of extension of the massaging protrusions through the support plane is zero during a part of the circular or elliptical motion.

3. A breast massager according to claim 14, wherein each massaging protrusion is arranged to extend through the support plane at a different phase angle of the circular or elliptical motion.

4. A breast massager according to claim 1, wherein the massaging protrusions are coupled by a stiff beam.

5. A breast massager according to claim 4, wherein the massaging protrusions and the stiff beam are integrally formed.

6. A breast massager according to claim 4, wherein the stiff beam is driven by a crankshaft, the crankshaft being driven by the actuator.

7. A breast massager according to claim 6, wherein the crankshaft is arranged to execute a circular motion.

8. A breast massager according to claim 1, wherein a first protrusion is coupled to a first gear wheel, a second protrusion is coupled to a second gear wheel, an intermediate gear wheel is coupled to the first gear wheel and the second gear wheel and where the first gear wheel is arranged to be driven by the actuator.

9. A breast massager according claim 1, wherein the first protrusion is coupled to a first gear wheel, a second protrusion is coupled to a second gear wheel, a gear belt is coupled to the first gear wheel and the second gear wheel and wherein the gear belt is arranged to be driven by the actuator.

10. A breast massager according to claim 8, wherein the circular or elliptical motions differ in amplitude.

11. A breast massager according to claim 1, wherein the breast massager comprises four protrusions.

12. A breast massager according to claim 1, wherein the massaging protrusions are covered by a plastic sleeve.

13. A breast massager according to claim 1, wherein the massaging protrusions are covered by a rubber or silicone sleeve.
